(19) United States
(12) Patent Application Publication
(10) Pub. No.: US 2025/0236973 A1
(43) Pub. Date: Jul. 24, 2025

(54) METHOD OF MANUFACTURING HIGHLY ACTIVE OXYGEN EVOLUTION ELECTRODE FOR WATER ELECTROLYSIS

(71) Applicant: GWANGJU INSTITUTE OF SCIENCE AND TECHNOLOGY, Gwangju (KR)

(72) Inventors: Jong Hoon JOO, Gwangju (KR); Hye Ri KIM, Gwangju (KR)

(21) Appl. No.: 19/007,462

(22) Filed: Dec. 31, 2024

(30) Foreign Application Priority Data
Jan. 23, 2024 (KR) 10-2024-0009961
Dec. 12, 2024 (KR) 10-2024-0185131

(51) Int. Cl. C25B 11/053; C25B 11/031; C25B 11/061; C25B 11/091

(52) U.S. Cl. CPC C25B 11/053; C25B 11/031; C25B 11/061; C25B 11/091

(57) ABSTRACT

The present inventive concept relates to a method of manufacturing a highly active oxygen evolution electrode used in an alkaline water electrolysis cell. According to the present inventive concept, a simple method of exposing the surface of a nickel electrode to water vapor induces the formation of a hydroxide layer including NiOOH and Ni(OH)₂ on the surface of the nickel electrode, and in the formed hydroxide layer, especially NiOOH improves oxygen evolution reaction (OER) activity, lowers the overpotential, and improves charge transfer dynamics, thereby significantly improving the oxygen evolution reaction performance and long-term stability of the nickel electrode. Therefore, the nickel electrode on which the hydroxide layer is formed can be usefully used as a water electrolysis oxygen evolution electrode.

### CROSS-REFERENCE TO RELATED APPLICATION

This application claims priority to and the benefit of Korean Patent Application No. 2024-0009961, filed on Jan. 23, 2024, and Korean Patent Application No. 2024-0185131, filed on Dec. 12, 2024, the disclosure of which are incorporated herein by reference in their entirety.

### BACKGROUND

### 1. Field of the Inventive Concept

The present inventive concept relates to a water treatment cell, and more specifically, to an oxygen evolution electrode used in an alkaline water electrolysis cell.

### 2. Discussion of Related Art

In alkaline water electrolysis, the stack accounts for 50% of the total cost, and since the electrode cost is half of the stack cost, reducing the electrode cost is one of the ways to lower the unit cost of hydrogen production. Therefore, the development of electrodes with high energy efficiency and economic feasibility is very important for the commercialization of alkaline water electrolysis.

Currently, for electrode research for commercialization of alkaline water electrolysis, the focus is on a method of depositing a catalyst on a conductive electrode (substrate) for use, and in this case, there are difficulties such as 1) limitations in material selection for different deposition methods for each material, 2) difficulties in the deposition process in large-area/mass production technology for commercialization, and 3) enormous facility and equipment investment costs depending on the deposition method.

Accordingly, a new electrode manufacturing method is required for the development of a commercializable water electrolysis electrode.

### RELATED ART DOCUMENT

### Patent Document

Korea Patent Publication No. 10-2015-0103864

### SUMMARY OF THE INVENTIVE CONCEPT

The problem to be solved by the present inventive concept is to improve the shortcomings and problems of the related art as described above, and to provide a method of manufacturing a highly active oxygen evolution electrode for water electrolysis.

The technical problems to be solved by the present inventive concept are not limited to the technical problems mentioned above, and other technical problems not mentioned can be clearly understood by a person having ordinary skill in the technical field to which the present inventive concept belongs from the description below.

In order to solve the above problems, one aspect of the present inventive concept provides a method of manufacturing a highly active oxygen evolution electrode for water electrolysis. The method of manufacturing a highly active oxygen evolution electrode for water electrolysis includes exposing a surface of a nickel electrode to water vapor; and heat-treating the electrode exposed to water vapor.

The exposure to water vapor may be exposure to a mixture of a carrier gas with the water vapor.

The carrier gas may be hydrogen gas.

The water vapor concentration may be 40% or more.

The exposure to water vapor may be performed at 250 to 350° C.

The exposure to water vapor may form a hydroxide layer on a surface of a nickel electrode.

The hydroxide layer may include NiOOH and Ni(OH)₂.

In the hydroxide layer, a surface area of NiOOH is characterized as being greater than a surface area of Ni(OH)₂.

The NiOOH may occupy 60 to 90% of a surface area of the hydroxide layer.

The nickel electrode may be a porous nickel electrode.

The porosity of the porous nickel electrode may be 90% or more.

The method may further include removing impurities on the surface of the nickel electrode prior to the exposure to water vapor.

In addition, the method may further include depositing a catalyst on the electrode after the heat-treating of the electrode exposed to the water vapor.

The catalyst may be a double layer hydroxide (LDH)-based catalyst.

In addition, another aspect of the present inventive concept provides a highly active oxygen evolution electrode for water electrolysis. The highly active oxygen evolution electrode for water electrolysis includes a nickel electrode; and a hydroxide layer formed on a surface of the nickel electrode by exposure to water vapor.

The nickel electrode may be a porous nickel electrode.

The porosity of the porous nickel electrode may be 90% or more.

The hydroxide layer may include NiOOH and Ni(OH)₂.

In the hydroxide layer, a surface area of NiOOH is characterized as being greater than a surface area of Ni(OH)₂.

The NiOOH may occupy 60 to 90% of a surface area of the hydroxide layer.

The highly active oxygen evolution electrode for water electrolysis may further include a catalyst formed on the hydroxide layer.

The catalyst may be a double layer hydroxide (LDH)-based catalyst.

### BRIEF DESCRIPTION OF THE DRAWINGS

The above and other objects, features and advantages of the present inventive concept will become more apparent to those of ordinary skill in the art by describing exemplary embodiments thereof in detail with reference to the accompanying drawings, in which:

FIG. 1 is a schematic diagram showing a method of manufacturing a highly active electrode for water electrolysis through water vapor treatment on a porous nickel electrode according to one embodiment of the present inventive concept;

FIG. 2 is an X-ray diffraction analysis spectrum of the surface of a porous nickel electrode before and after water vapor treatment according to a comparative example and an embodiment of the present inventive concept;

FIG. 3 is an X-ray diffraction analysis spectrum of the surface of a porous nickel electrode on which a catalyst is deposited after water vapor treatment according to one embodiment of the present inventive concept;

FIG. 4 is a photograph of the surface of a porous nickel electrode before and after water vapor treatment according to a comparative example and an embodiment of the present inventive concept, taken using an SEM;

FIG. 5 is a photograph of the surface of a porous nickel electrode on which a catalyst is deposited before and after water vapor treatment according to a comparative example and an embodiment of the present inventive concept, taken using an SEM;

FIG. 6 is a photograph of the surface of a porous nickel electrode before water vapor treatment according to one embodiment of the present inventive concept and a photograph of the surface of a porous nickel electrode according to the concentration of water vapor being treated during water vapor treatment according to one embodiment, taken using a TEM;

FIG. 7 is an Ni 2p_{3/2} graph obtained by XPS analysis of the surface of a porous nickel electrode before and after water vapor treatment according to one embodiment of the present inventive concept;

FIG. 8 is an O 1s graph obtained by XPS analysis of the surface of a porous nickel electrode before and after water vapor treatment according to one embodiment of the present inventive concept;

FIG. 9 is a graph showing the peak area percentages of Ni⁰, Ni²⁺, and Ni³⁺ in the Ni 2p_{3/2} graph obtained by XPS analysis of a porous nickel electrode surface before and after water vapor treatment according to one embodiment of the present inventive concept;

FIG. 10 is a graph showing the peak area percentages of M-O, H₂O, and M-OH in an O 1s graph obtained by XPS analysis of a porous nickel electrode surface before and after water vapor treatment according to one embodiment of the present inventive concept;

FIG. 11 is a graph showing changes in the Ni²⁺ content and Ni³⁺ content of a porous nickel electrode according to a comparative example before water vapor treatment and a porous nickel electrode according to the concentration of water vapor being treated during water vapor treatment according to one embodiment of the present inventive concept;

FIG. 12 is a graph showing changes in the Ni²⁺ content and Ni³⁺ content after pre-activation through cyclic voltammetry (CV) of a porous nickel electrode according to a comparative example before water vapor treatment and a porous nickel electrode according to the concentration of water vapor being treated during water vapor treatment according to one embodiment of the present inventive concept;

FIG. 13 is a graph comparing the performance of a porous nickel electrode for an oxygen evolution reaction according to the concentration of water vapor treatment according to one embodiment of the present inventive concept;

FIG. 14 is a Nyquist plot showing the resistance of a porous nickel electrode for an oxygen evolution reaction according to the concentration of water vapor treatment according to one embodiment of the present inventive concept;

FIG. 15 shows a three-dimensional distribution of relaxation time (DRT) plot according to overvoltage of a porous nickel electrode treated with water vapor according to one embodiment of the present inventive concept;

FIG. 16 shows a contour plot according to the overvoltage of a porous nickel electrode treated with water vapor according to one embodiment of the present inventive concept;

FIG. 17 shows distribution of relaxation time (DRT) plots according to the water vapor treatment concentration of a porous nickel electrode treated with water vapor according to one embodiment of the present inventive concept;

FIG. 18 shows the change in Gibbs energy of Ni, NiOOH, and Ni(OH)₂ surfaces in a step-by-step reaction path of an oxygen evolution reaction (OER) when performing the OER using a water vapor-treated nickel electrode according to one embodiment of the present inventive concept;

FIG. 19 shows the change in reaction energy according to the reaction path when the hydrogen ion (H⁺) source provided to NiOOH is water vapor (H₂O) and when it is hydrogen (H₂) when a nickel electrode is treated with water vapor according to one embodiment of the present inventive concept;

FIG. 20 is an image showing the surface movement trajectories of H₂ and H₂O according to the concentration of the treated water vapor when a nickel electrode is treated with water vapor according to one embodiment of the present inventive concept;

FIG. 21 is a schematic diagram showing the configuration of a nickel electrode surface when a nickel electrode is treated with water vapor according to one embodiment of the present inventive concept;

FIGS. 22 to 24 are graphs comparing the performance of the porous nickel electrode of Manufacturing Examples 3 and 4 treated with a water vapor concentration of 40% according to one embodiment of the present inventive concept with conventional water electrolysis electrodes; and

FIG. 25 is a comparative graph of long-term stability when performing an oxygen evolution reaction using an electrode in which a catalyst (NiFe LDH) is deposited on a porous nickel substrate treated with a 40% concentration of water vapor according to one embodiment of the present inventive concept and an electrode in which a catalyst (NiFe LDH) is deposited on a porous nickel substrate without water vapor treatment according to a comparative example.

### DETAILED DESCRIPTION OF EXEMPLARY EMBODIMENTS

Since the present inventive concept can undergo various changes and have various embodiments, specific embodiments are illustrated in the drawings and described in detail. However, this is not intended to limit the present inventive concept to specific embodiments, and it should be understood to include all modifications, equivalents and substitutes included in the spirit and scope of the present inventive concept.

The terms used in the present inventive concept are only used to describe specific embodiments, and are not intended to limit the present inventive concept. Singular expressions include plural expressions unless the context clearly dictates otherwise.

In the present inventive concept, it is to be understood that the terms “include(s)” or “have (has)” and the like are intended to specify the presence of stated features, numbers, steps, operations, components, parts, or combinations thereof, but do not preclude the presence or addition of one or more other features, numbers, steps, operations, components, parts, or combinations thereof.

In the present inventive concept, terms such as first, second, and the like may be used to describe various components, but the components may not be limited by the terms. The terms may be used only for the purpose of distinguishing one component from another.

In the present inventive concept, when it is mentioned that a component is “connected” or “coupled” to another component, it can be understood that it may be directly connected or coupled to the other component, but there may also be other components present therebetween. On the other hand, when a component is said to be “directly connected” or “directly coupled” to another component, it can be understood that there are no other components therebetween.

In the present inventive concept, when a part such as a layer, film, region, plate, etc. is described as being “on” another part, it includes not only the case where the part is “directly on” the other part, but also the case when there is another part therebetween. Conversely, when a part is said to be “directly on” another part, it means that there are no other parts therebetween.

Unless defined otherwise, all terms used herein, including technical or scientific terms, have the same meaning as commonly understood by one of ordinary skill in the art to which the present inventive concept belongs. Terms such as those defined in a commonly used dictionary should be interpreted as having a meaning consistent with the meaning in the context of the related art, and should not be interpreted in an ideal or excessively formal meaning unless explicitly defined in the present application.

One aspect of the present inventive concept provides a method of manufacturing a highly active oxygen evolution electrode for water electrolysis.

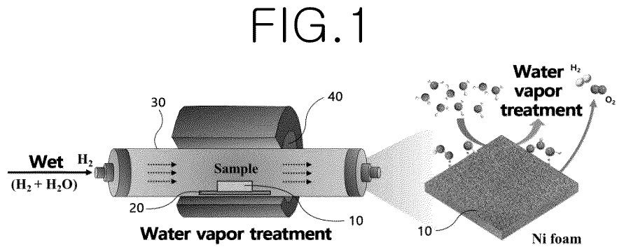

FIG. 1 is a schematic diagram showing a method of manufacturing a highly active oxygen evolution electrode for water electrolysis according to one embodiment of the present inventive concept.

Referring to FIG. 1, a method of manufacturing a highly active oxygen evolution electrode for water electrolysis according to the present inventive concept includes exposing a surface of a nickel electrode to water vapor; and heat-treating the electrode exposed to water vapor.

Hereinafter, the method of manufacturing a highly active oxygen evolution electrode for water electrolysis according to the present inventive concept will be described in detail for each step.

First, a nickel electrode is exposed to water vapor. However, since water vapor has a low vapor pressure of about 20 Torr at room temperature, and the vapor pressure changes greatly depending on the temperature, it is one of the gases that is difficult to control and flow in large quantities. Accordingly, it is preferable that the water vapor is introduced into a vacuum chamber 30 after being mixed with a carrier gas, and it is also preferable that the nickel electrode is disposed on a support member 20 within the vacuum chamber 30 so that the nickel electrode is exposed to the water vapor within the vacuum chamber.

Specifically, the supply of water vapor may be performed by inputting a carrier gas into water and bubbling it to input the carrier gas and water vapor together into the vacuum chamber. In this method, the amount of water vapor that can actually be introduced is only the partial pressure of the carrier gas and water vapor of the mixed gas. Accordingly, the concentration of water vapor that can be introduced may be controlled by controlling the partial pressure of the carrier gas and water vapor.

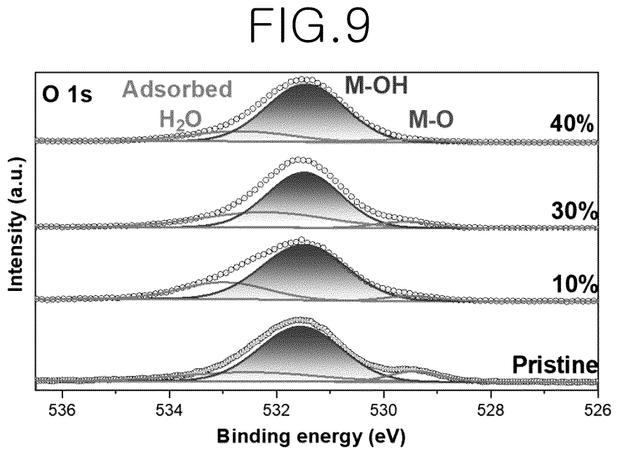

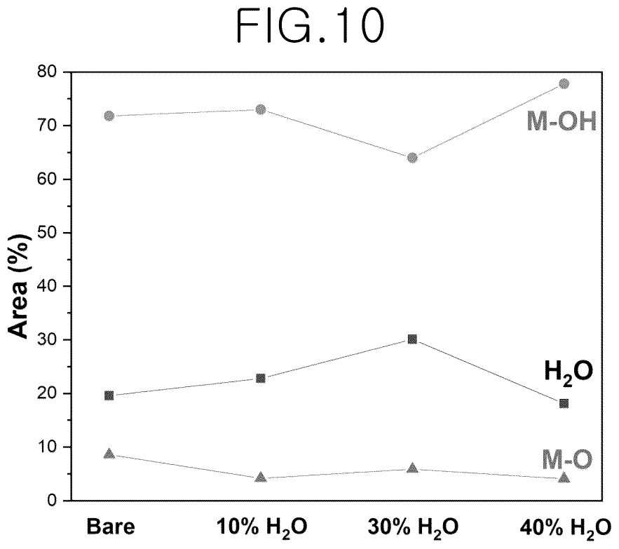

At this time, hydrogen gas may be used as the carrier gas. The hydrogen gas may prevent oxidation of the electrode at high temperatures. As described above, the concentration of the water vapor may be adjusted by controlling the partial pressure of the carrier gas and the water vapor. As shown in FIGS. 9 and 10, as the concentration of water vapor increases, the overvoltage for the oxygen evolution reaction of the nickel electrode decreases. In particular, when the water vapor concentration is 40% or more, since the surface resistance of the nickel electrode decreases to almost 0, it was confirmed that the oxygen evolution reaction is significantly improved. Therefore, during water vapor exposure, it is desirable to use a water vapor concentration of 40% or higher.

It is preferable that the water vapor exposure is performed at a temperature of 250 to 350° C. The above temperature may be maintained through a heating means 40 outside the vacuum chamber 30. When the nickel electrode is exposed to water vapor at the above temperature, a reaction as shown in the following Reaction Scheme 1 occurs between the water vapor and the surface of the nickel electrode, thereby forming a hydroxide layer on the surface of the nickel electrode.

Ni+2H₂O(g)→NiOOH+3/2H₂(g)

Ni+2H₂O(g)→Ni(OH)₂+H₂(g) [Reaction Scheme 1]

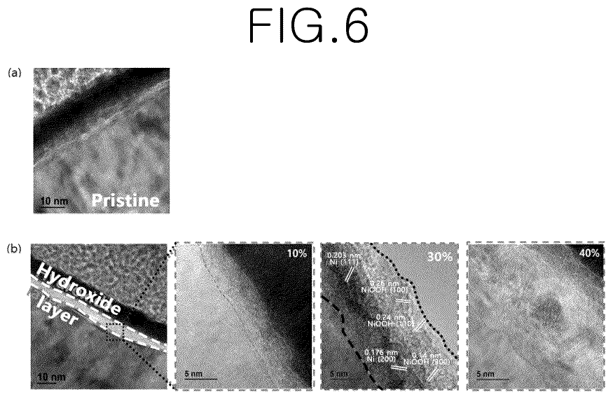

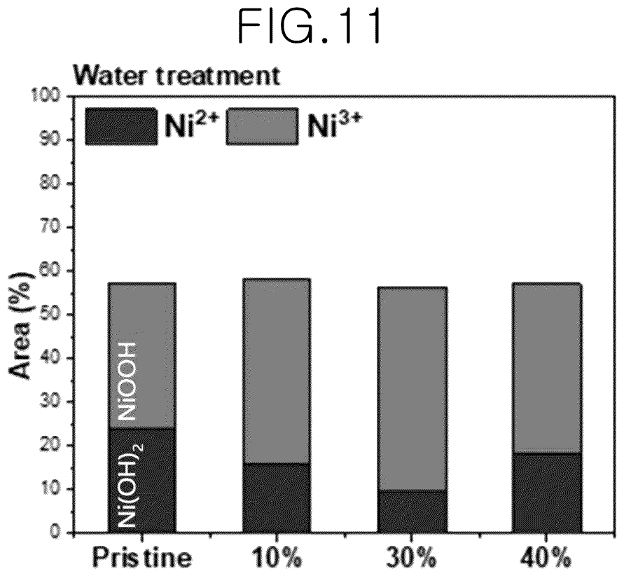

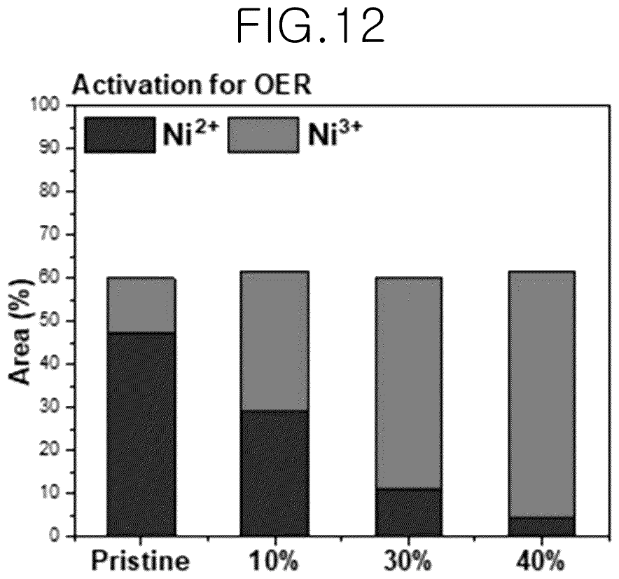

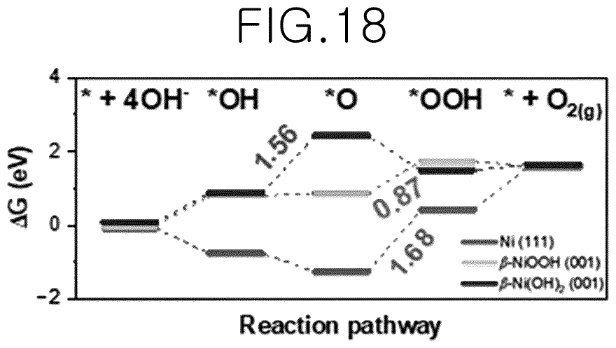

The hydroxide layer may include NiOOH and Ni(OH)₂, and in one embodiment of the present inventive concept, the formation of the hydroxide layer including NiOOH and Ni(OH)₂ can be confirmed through a transmission electron microscope (see FIG. 6). In the hydroxide layers, NiOOH exhibits excellent OER catalytic activity (see FIG. 18), and thus may improve the oxygen evolution reaction performance of the nickel electrode. It was confirmed that in the hydroxide layer, as shown in FIG. 11, the surface area of NiOOH is formed to be larger than that of Ni(OH)₂, and as shown in FIG. 12, after activation of the nickel electrode, as the concentration of water vapor treated increases, the content of Ni³⁺ proportionally increases, and thus a content of NiOOH increases. The NiOOH may occupy 60 to 90% of a surface area of the hydroxide layer.

The thickness of the hydroxide layer may be 1 to 15 nm, but is not limited thereto, and the hydroxide layer may be formed to a thickness at which oxygen evolution reaction performance is effectively improved.

The nickel electrode may be a porous nickel electrode. In the case of porous nickel bodies, since the surface area increases, the surface area of an NiOOH-containing hydroxide layer, which exhibits excellent oxygen evolution reaction catalytic activity and is formed by exposure to water vapor, can also increase, so that the oxygen evolution reaction performance can be further improved compared to non-porous bodies. At this time, the higher the porosity of the porous nickel electrode, the better it is. For example, it is preferable to have a porosity of 90% or more, but is not limited thereto.

The method may further include removing impurities on the surface of the nickel electrode prior to exposure to water vapor. The impurity removal process may use a method known in the art, and as an example, impurities may be removed through acid treatment, but the method is not limited thereto.

The nickel electrode may be heat-treated after exposure to water vapor. This heat treatment may be performed by a first heat treatment at 250 to 350° C. and then a second heat treatment at 30 to 60° C., but is not limited thereto.

In addition, the method may further include depositing a catalyst on the electrode after the heat-treating of the electrode exposed to the water vapor.

The catalyst may be a double layer hydroxide (LDH)-based catalyst, and may be, for example, an NiFe LDH catalyst, but is not limited thereto, and any catalyst used in the OER reaction may be used without limitation.

In addition, another aspect of the present inventive concept provides a highly active oxygen evolution electrode for water electrolysis.

The highly active oxygen evolution electrode for water electrolysis is manufactured by the manufacturing method according to the present inventive concept, and is characterized by including the nickel electrode; and a hydroxide layer formed on the surface of the nickel electrode by exposure to water vapor.

In addition, the highly active oxygen evolution electrode for water electrolysis may further include a catalyst formed on the hydroxide layer.

At this time, the composition and characteristics of the nickel electrode, the hydroxide layer, and the catalyst are as described above, so they are omitted to avoid redundant description.

According to the present inventive concept, a simple method of exposing the surface of a nickel electrode to water vapor induced the formation of a hydroxide layer including NiOOH and Ni(OH)₂ on the surface of the nickel electrode, and in the formed hydroxide layer, especially NiOOH improved OER activity, lowered the overpotential, and improved charge transfer dynamics, thereby significantly improving the oxygen evolution reaction performance and long-term stability of the nickel electrode. Therefore, the nickel electrode on which the hydroxide layer is formed can be usefully used as a water electrolysis oxygen evolution electrode.

Hereinafter, preferred manufacturing examples and experimental examples are presented to help understand the present inventive concept. However, the following manufacturing examples and experimental examples are only for helping to understand the present inventive concept, and the present inventive concept is not limited by the following manufacturing examples and experimental examples.

### Manufacturing Example 1: Manufacture of Highly Active Oxygen Evolution Electrode for Water Electrolysis

A porous nickel electrode (porosity>93%, thickness: 1.6 mm) was sonicated with 3 M HCl for 30 minutes before use, and then washed several times with distilled water and ethanol to remove surface impurities.

Thereafter, using the device of FIG. 1, each porous nickel electrode 10 was exposed to wet hydrogen (wet H₂) having a water vapor concentration of 10% at 300° C. for 10 hours to supply water vapor to the surface of the porous nickel electrode.

The porous nickel electrode exposed to wet hydrogen was sequentially heat-treated at 300° C. for 10 hours and at 30° C. for 5 hours in a reducing atmosphere to manufacture a highly active oxygen evolution electrode for water electrolysis.

### Manufacturing Example 2: Manufacture of Highly Active Oxygen Evolution Electrode for Water Electrolysis

A highly active oxygen evolution electrode for water electrolysis was manufactured in the same manner as in Manufacturing Example 1, except that the porous nickel electrode was exposed to wet hydrogen having a water vapor concentration of 30% instead of 10%.

### Manufacturing Example 3: Manufacturing of Highly Active Oxygen Evolution Electrode for Water Electrolysis

A highly active oxygen evolution electrode for water electrolysis was manufactured in the same manner as in Manufacturing Example 1, except that the porous nickel electrode was exposed to wet hydrogen having a water vapor concentration of 40% instead of 10%.

### Manufacturing Example 4: Manufacture of Highly Active Oxygen Evolution Electrode for Water Electrolysis Including Catalyst

NiFe double layer hydroxide (LDH) was deposited as a catalyst on the highly active oxygen evolution electrode for water electrolysis manufactured in Manufacturing Example 3.

### Comparative Example 1

A porous nickel electrode was used as an electrode without surface treatment (pristine Ni foam).

### Comparative Example 2

NiFe double layer hydroxide (LDH) was deposited as a catalyst on the porous nickel electrode of Comparative Example 1.

### <Analysis>

### 1. X-Ray Diffraction Analysis

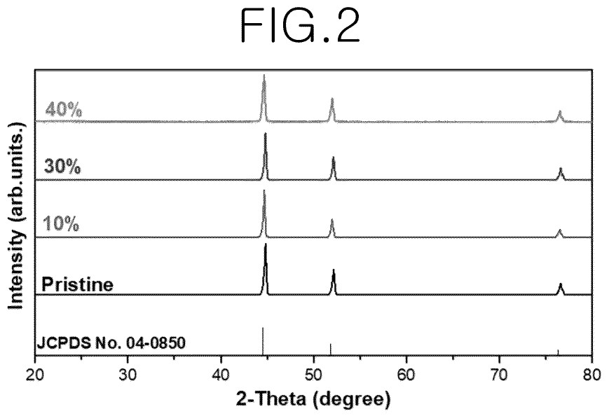

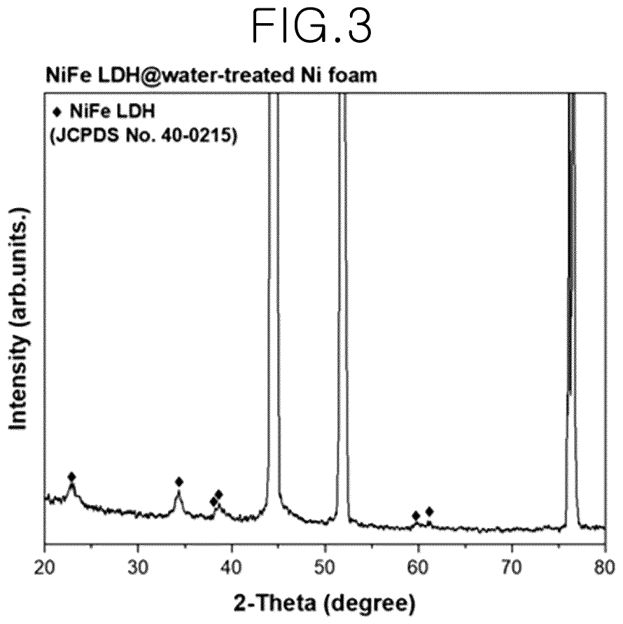

The surfaces of the porous nickel electrodes of Manufacturing Examples 1 to 3 and Comparative Example 1 were subjected to X-ray diffraction (XRD) analysis, and the results are shown in FIG. 2, and the surface of the porous nickel electrode of Manufacturing Example 4 was subjected to X-ray diffraction (XRD) analysis, and the results are shown in FIG. 3.

FIGS. 2 and 3 are XRD spectra showing the results of XRD analysis of the surface of a porous nickel electrode before and after water vapor treatment according to one embodiment of the present inventive concept.

As shown in FIG. 2, the surface of the porous nickel electrode before and after water vapor treatment exhibited the same crystal structure with three distinct diffraction peaks as shown in the reference (JCPDS Card No. 04-0850) without peak shift. This shows that the crystal structure within the porous nickel electrode remains unchanged under various water vapor treatment conditions, so that the internal intrinsic crystal metal phase can sufficiently perform the role of an electron conductor.

In addition, as shown in FIG. 3, when an NiFe LDH catalyst was deposited on the porous nickel electrode after the water vapor treatment, an NiFe LDH peak appeared in the XRD spectrum, and thus it was confirmed that the catalyst deposition was successful.

### 2. Surface Analysis by Scanning Electron Microscope

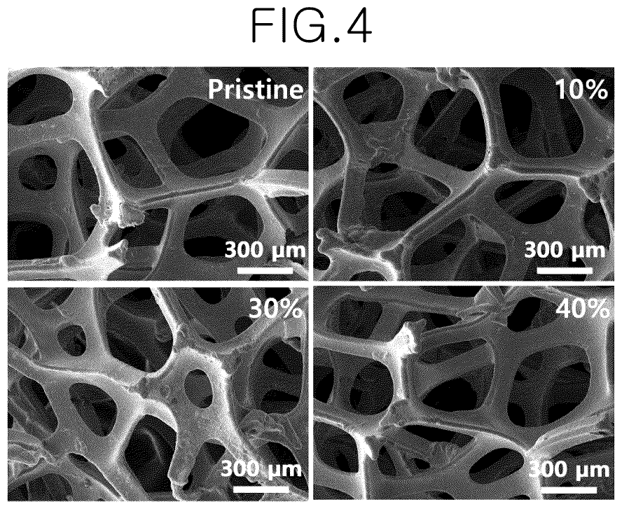

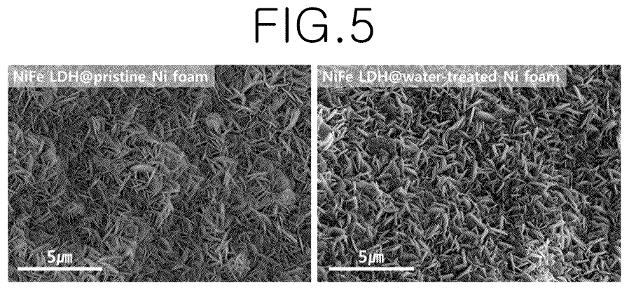

The surfaces of the porous nickel electrodes of Manufacturing Examples 1 to 3 and Comparative Example 1 were observed using a scanning electron microscope (SEM), and are shown in FIG. 4, and the surfaces of the porous nickel electrodes including the catalysts of Manufacturing Example 4 and Comparative Example 2 were observed using a scanning electron microscope (SEM), and the results are shown in FIG. 5.

FIG. 4 is a photograph of the surface of a porous nickel electrode before and after water vapor treatment according to a comparative example and an embodiment of the present inventive concept, taken using an SEM, and FIG. 5 is a photograph of the surface of a porous nickel electrode on which a catalyst is deposited before and after water vapor treatment according to a comparative example and an embodiment of the present inventive concept, taken using an SEM.

As shown in FIG. 4, as a result of comparing the surface morphology of porous nickel bodies before and after water vapor treatment, no change in the porous network structure of the porous nickel body was observed regardless of the conditions of water vapor treatment, indicating that the change in surface area does not act as a factor affecting the oxygen evolution reaction.

As shown in FIG. 5, it was confirmed that the double hydroxide-based catalyst was successfully deposited on the porous nickel body.

### 3. Surface Analysis by Transmission Electron Microscope

Next, the surfaces of the porous nickel electrodes of Example 2 and Comparative Example 1 were observed using a transmission electron microscope (TEM), and the results are shown in FIG. 6.

FIG. 6 is a photograph of the surface of a porous nickel electrode before water vapor treatment according to one embodiment of the present inventive concept and a photograph of the surface of a porous nickel electrode according to the concentration of water vapor being treated during water vapor treatment according to one embodiment, taken using a TEM.

As shown in FIG. 6, in the present inventive concept, it was confirmed that a hydroxide layer was formed on the surface of the porous nickel electrode after water vapor treatment, and a thickness of the hydroxide layer was formed to be 5 to 15 nm depending on the concentration of water vapor being treated.

As a result of analyzing the composition by observing the hydroxide layer using a high-resolution TEM, the hydroxide layer showed three different lattice crystals with sizes of 0.26 nm, 0.24 nm, and 0.14 nm, respectively, aligned with the (100) plane, (110) plane, and (300) plane of NiOOH, and the (101) plane of Ni(OH)₂ of about 0.233 nm was also confirmed. Therefore, it was confirmed that a hydroxide layer, presumed to be Ni(OH)₂ and NiOOH, was formed on the surface of the porous nickel electrode after the porous nickel electrode was treated with water vapor. It was confirmed that the thickness of the hydroxide layer increases as the concentration of water vapor being treated increases.

### 4. X-Ray Photoelectron Spectroscopy (XPS)

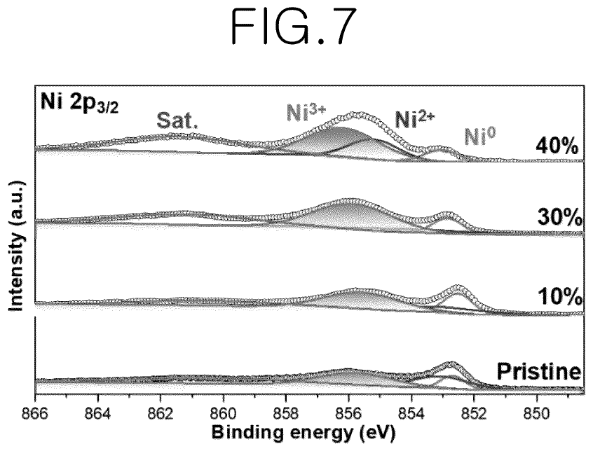

To further investigate the chemical composition and oxidation state of the porous nickel electrode surface before and after water vapor treatment, X-ray photoelectron spectroscopy (XPS) was performed, and the results are shown in FIGS. 7 to 10.

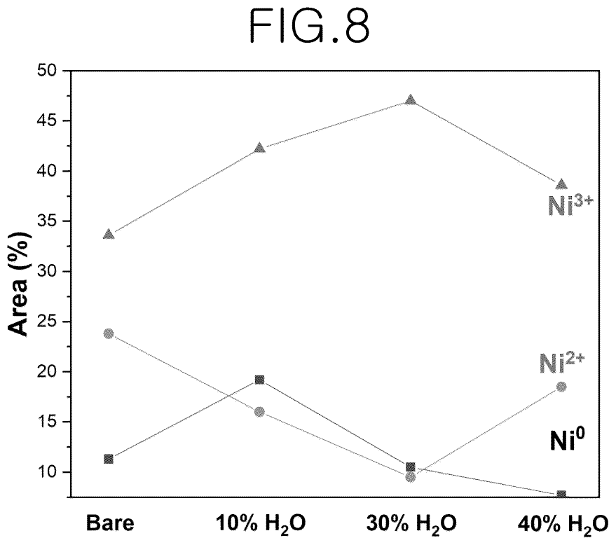

FIG. 7 is an Ni 2p_{3/2} graph obtained by XPS analysis of the surface of a porous nickel electrode before and after water vapor treatment according to one embodiment of the present inventive concept, and FIG. 8 shows the peak area percentages of Ni⁰, Ni²⁺, and Ni³⁺ in the Ni 2p_{3/2} graph.

As shown in FIG. 7, after water vapor treatment, the binding energy peak on the surface of the porous nickel electrode shifted from about 852 eV to about 856 eV and about 861 eV depending on the concentration of the water vapor, the content of neutral Ni decreased, and significant changes were observed in the two peaks corresponding to Ni²⁺ and Ni³⁺. This is due to the layer of hydroxide such as Ni(OH)₂ or NiOOH on the surface. In particular, as shown in FIG. 8, the peak area of Ni³⁺ increased as the water vapor concentration increased, suggesting that the water vapor treatment induced the formation of an NiOOH layer on the surface, which is also consistent with the TEM results.

FIG. 9 is an O 1s graph obtained by XPS analysis of a porous nickel electrode surface before and after water vapor treatment according to one embodiment of the present inventive concept, and FIG. 10 is a graph showing the peak area percentages of M-O, H₂O, and M-OH in the O 1s graph.

The O 1s XPS spectrum in FIG. 9 shows three peaks at 529.4, 531.4, and 532.3 eV, which correspond to lattice oxygen (M-O), hydroxide (M-OH), and adsorbed H₂O, respectively. In addition, as shown in FIG. 10, the percentage of Ni²⁺ derived from Ni(OH)₂ or NiO decreased after water vapor treatment (10%), but the peak areas of M-O and M-OH bonds remained constant, so it can be reasonably assumed that the Ni(OH)₂ layer decreased and an NiOOH layer was formed on the surface during water vapor treatment.

### Experimental Example 1: Measurement of Oxygen Evolution Reaction Performance According to Water Vapor Treatment of Porous Nickel Electrode

To determine the effect of water vapor treatment of a porous nickel electrode according to the present inventive concept on the OER, the following experiments were performed.

Specifically, before performing the OER measurement, the Ni²⁺ content and Ni³⁺ content were measured for the porous nickel electrode of Comparative Example 1 before water vapor treatment and the porous nickel electrodes of Examples 1 to 3 after water vapor treatment, and the results are shown in FIG. 11.

Next, for the four porous nickel electrodes, after the porous nickel electrodes were pre-activated through cyclic voltammetry (CV) at a scan rate of 100 mV/s, the Ni²⁺ content and Ni³⁺ content were measured and are shown in FIG. 12.

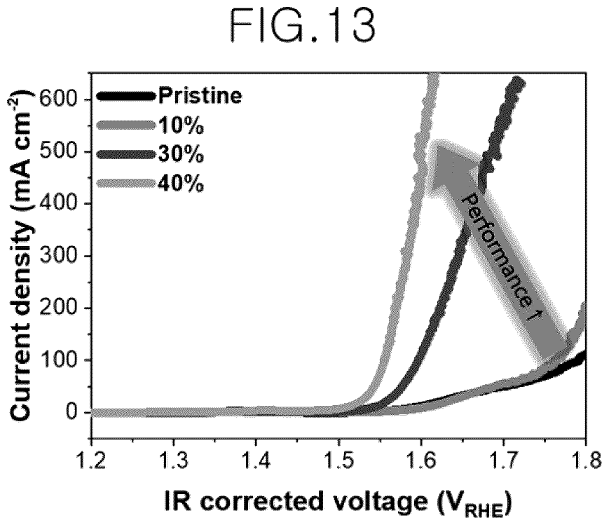

Next, for the four nickel porous electrodes, the overvoltage was measured through the OER polarization curve with iR compensation with reference to the reversible hydrogen electrode (RHE), and the results are shown in FIG. 13.

FIG. 11 is a graph showing changes in the Ni²⁺ content and Ni³⁺ content of a porous nickel electrode according to a comparative example before water vapor treatment and a porous nickel electrode according to the concentration of water vapor being treated during water vapor treatment according to one embodiment of the present inventive concept.

FIG. 12 is a graph showing changes in the Ni²⁺ content and Ni³⁺ content after pre-activation through cyclic voltammetry (CV) of a porous nickel electrode according to a comparative example before water vapor treatment and a porous nickel electrode according to the concentration of water vapor being treated during water vapor treatment according to one embodiment of the present inventive concept.

FIG. 13 is a graph comparing the performance of a porous nickel electrode for an oxygen evolution reaction according to the concentration of water vapor treatment according to one embodiment of the present inventive concept.

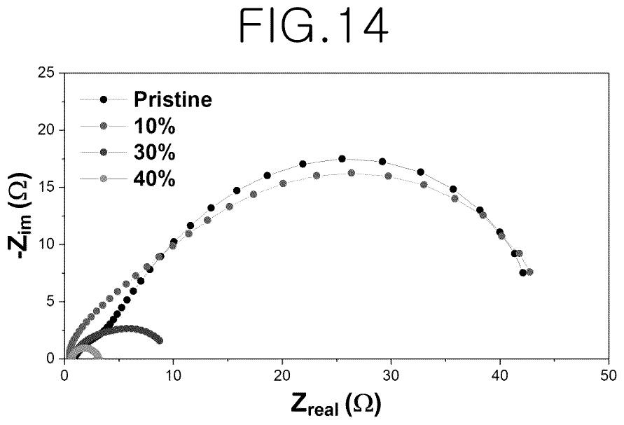

It was confirmed that as shown in FIG. 11, when performing water treatment on a porous nickel electrode, the oxidation number of nickel increases, in particular, after pre-activation of the nickel electrode through CV, as the concentration of water vapor treated increases, the content of Ni³⁺ proportionally increases, and thus a content of NiOOH increases, and as shown in FIG. 13, the overvoltage for the OER decreases as the concentration of water vapor being treated increases. Next, electrochemical impedance spectroscopy (EIS) was performed, and the results are shown in FIG. 14.

FIG. 14 is a Nyquist plot showing the resistance of a porous nickel electrode for an oxygen evolution reaction according to the concentration of water vapor treatment according to one embodiment of the present inventive concept.

In the Nyquist plot, the semicircle corresponds to the polarization resistance (Rp) including the charge transfer resistance (Rct).

As shown in FIG. 14, it was confirmed that the diameter of the semicircle indicating the polarization resistance was about 40 (before water vapor treatment, but rapidly decreased as the water vapor treatment concentration increased after water vapor treatment, and in particular, when the water vapor concentration was 40%, the diameter of the polarization resistance semicircle decreased to less than 5 $2, indicating that the resistance to the oxygen evolution reaction was significantly reduced, and through this, the oxygen evolution reaction performance was significantly improved.

This is thought to be because the hydroxide layer (NiOOH) formed on the porous nickel electrode surface after water vapor treatment exhibits high activity for the oxygen evolution reaction, and through this, it can be seen that the NiOOH layer induces high activity for the oxygen evolution reaction.

### Experimental Example 2: Analysis of Distribution of Relaxation Time (DRT) Plot

Thereafter, a more comprehensive analysis of the catalytic dynamics occurring at the electrode-electrolyte interface was performed by applying the distribution of relaxation time (DRT) plots derived from the Nyquist diagram using a Gaussian basis function.

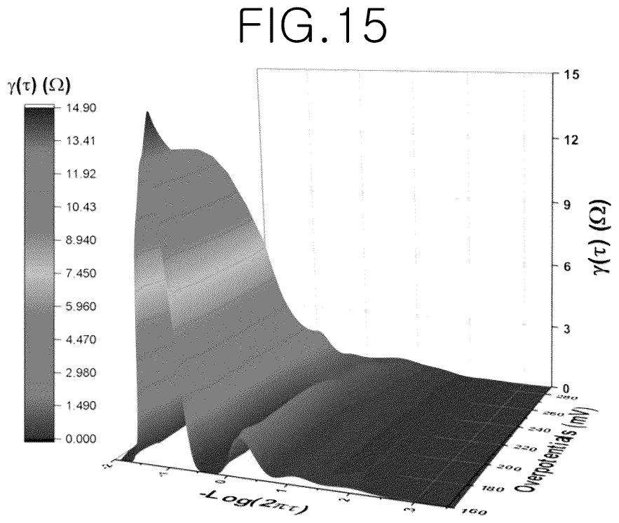

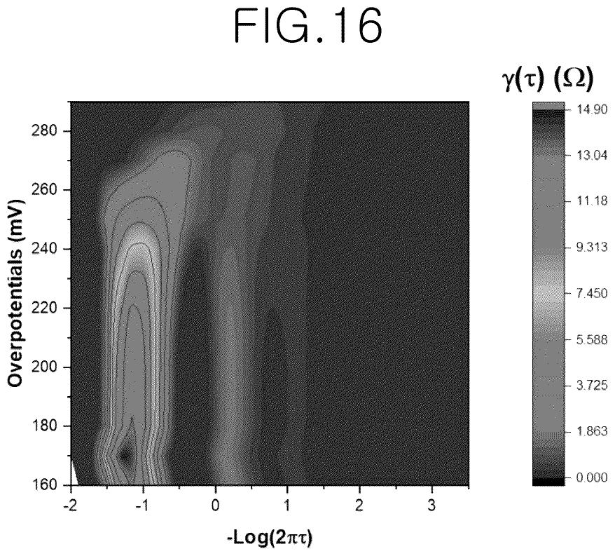

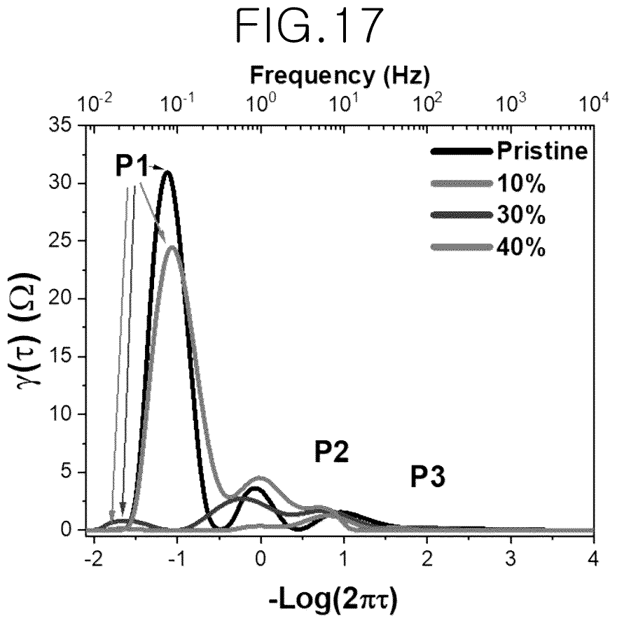

Specifically, an oxygen evolution reaction was performed on the porous nickel electrode of Manufacturing Example 3 treated with water vapor having a water vapor concentration of 40%, and a three-dimensional DRT plot and a contour plot according to overvoltage were measured and presented in FIGS. 15 and 16, respectively, and a DRT plot according to water vapor concentration was measured and presented in FIG. 17.

FIG. 15 shows a three-dimensional distribution of relaxation time (DRT) plot according to overvoltage of a porous nickel electrode treated with water vapor according to one embodiment of the present inventive concept, FIG. 16 shows a contour plot according to the overvoltage of a porous nickel electrode treated with water vapor according to one embodiment of the present inventive concept, and FIG. 17 shows distribution of relaxation time (DRT) plots according to the water vapor treatment concentration of a porous nickel electrode treated with water vapor according to one embodiment of the present inventive concept.

As shown in FIGS. 15 to 17, the plots show three prominent peaks, including P1, P2, and P3 peaks, which represent resistance factors for sub-reactions of various electrochemical processes occurring at the electrode and electrolyte interface, with each peak area representing the magnitude of the resistance for a specific electrochemical reaction. The P2 and P3 peaks corresponding to the mid-frequency and low-frequency regions can appear due to gas diffusion and adsorption/desorption of active species, respectively.

As shown in FIGS. 15 and 16, y (t) decreases significantly as the overvoltage increases, which can be assumed to be the peak corresponding to the charge transfer process associated with the water decomposition reaction, which is the most prominent peak, the P1 peak.

As shown in FIG. 17, the P1 peak significantly decreased as the water vapor concentration increased, and in particular, when the water vapor concentration was 40%, the P1 peak almost disappeared, indicating that there was almost no resistance. This shows that surface changes of the nickel electrode (e.g., formation of a hydroxide layer) due to water vapor treatment dramatically improve the charge transfer process.

### Experimental Example 3: Identification of the Oxygen Evolution Reaction Activation Mechanism of Water Vapor-Treated Nickel Electrode

In order to determine the mechanism by which the reaction activity is enhanced when performing the OER using a water vapor-treated nickel electrode according to the present inventive concept, the following experiment was performed.

First, the Gibbs energy change in the step-by-step reaction path of the OER on Ni, NiOOH, and Ni(OH)₂ present on the nickel electrode surface was calculated and the results are shown in FIG. 18.

FIG. 18 shows the change in Gibbs energy of Ni, NiOOH, and Ni(OH)₂ surfaces in a step-by-step reaction path of the OER when performing the OER using a water vapor-treated nickel electrode according to one embodiment of the present inventive concept.

As shown in FIG. 18, in the OER reaction path, when the rate determining step (RDS) with the highest energy barrier is compared, it can be seen that Ni shows 1.68 eV, NiOOH shows 0.87 eV, and Ni(OH)₂ shows 1.56 eV, indicating that NiOOH has a lower energy barrier for the OER reaction than Ni and Ni(OH)₂, and thus has higher OER reaction activity.

However, since the reaction of NiOOH+½H₂(g)→Ni(OH)₂ is generally a spontaneous reaction, it is important to maintain the state of NiOOH by suppressing the reaction of NiOOH to Ni(OH)₂ to increase the OER activity of the nickel electrode.

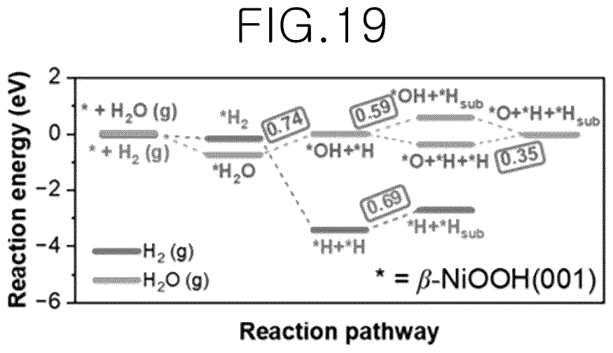

Meanwhile, when a nickel electrode is treated with water vapor according to the present inventive concept, the porous nickel electrode is exposed to wet hydrogen (wet H₂) including water vapor. At this time, the reaction energy according to the reaction path when the hydrogen ion (H⁺) source provided to NiOOH is water vapor and when it is hydrogen was calculated, and the results are shown in FIG. 19.

FIG. 19 shows the change in reaction energy according to the reaction path when the hydrogen ion (H⁺) source provided to NiOOH is water vapor (H₂O) and when it is hydrogen (H₂) when a nickel electrode is treated with water vapor according to one embodiment of the present inventive concept.

As shown in FIG. 19, when the hydrogen ion (H⁺) source provided to NiOOH is water vapor (H₂O), it can be seen that the reaction from NiOOH to Ni(OH)₂ is difficult because at least 1.09 eV is required due to the energy barrier according to the reaction path.

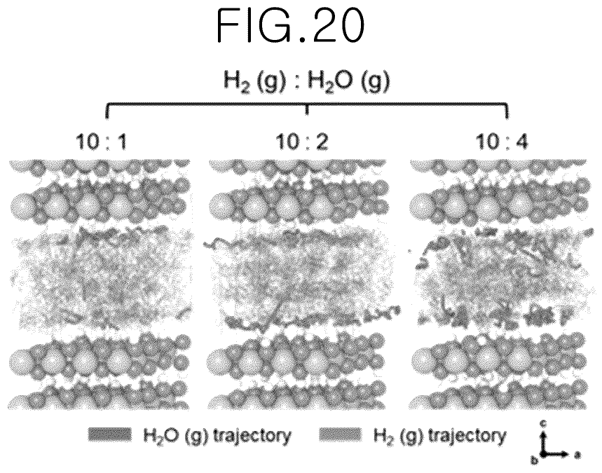

In addition, when a nickel electrode is treated with water vapor according to the present inventive concept, the surface movement trajectories of H₂ and H₂O were calculated according to the concentration of the treated water vapor, and the results are shown in FIG. 20.

FIG. 20 is an image showing the surface movement trajectories of H₂ and H₂O according to the concentration of the treated water vapor when a nickel electrode is treated with water vapor according to one embodiment of the present inventive concept.

As shown in FIG. 20, it can be seen that as the concentration of water vapor being treated increases, water vapor forms traps on the nickel surface.

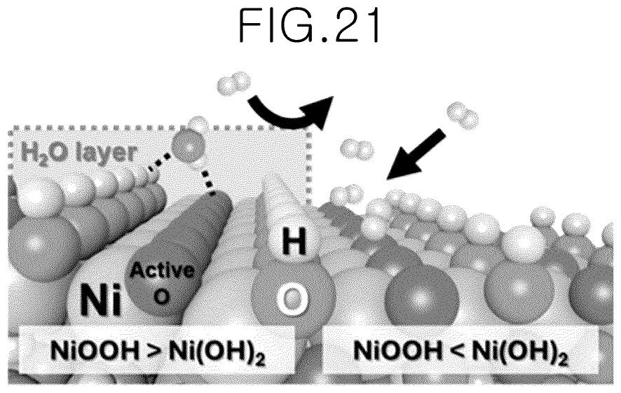

FIG. 21 is a schematic diagram showing the configuration of a nickel electrode surface when a nickel electrode is treated with water vapor according to one embodiment of the present inventive concept.

As shown in FIG. 21, when the nickel electrode is treated with water vapor according to the present inventive concept, water vapor (H₂O) surrounds the surface of the nickel electrode and forms a trap layer, thereby suppressing the conversion of NiOOH to Ni(OH)₂ to maintain high OER activity by NiOOH.

### Experimental Example 4: Comparison of Catalytic Performance of Water Vapor-Treated Porous Nickel Electrode with Conventional Water Electrolysis Electrode

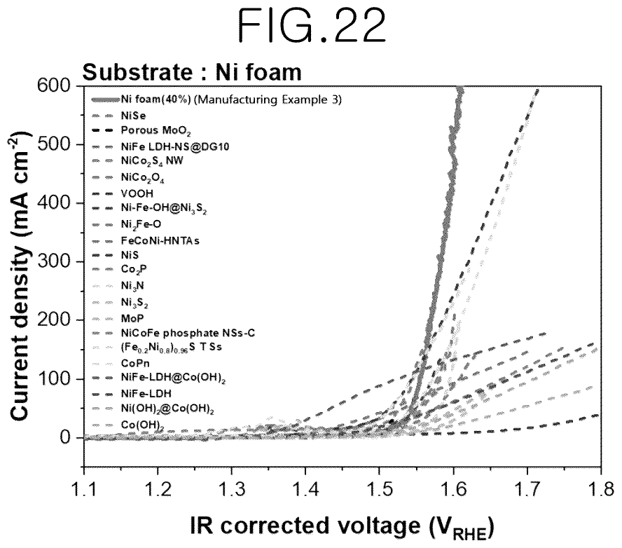

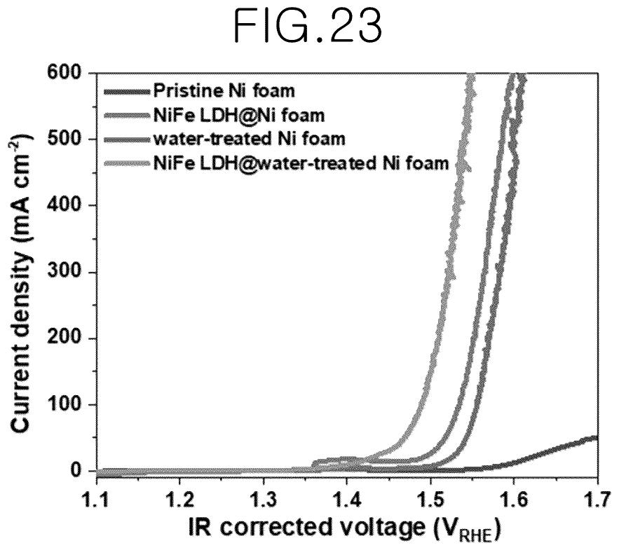

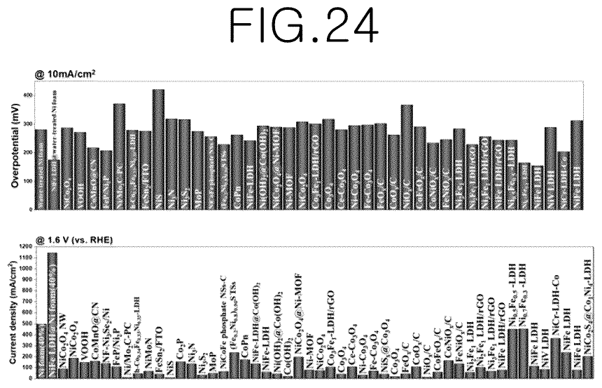

FIGS. 22 to 24 are graphs comparing the performance of the porous nickel electrode of Manufacturing Examples 3 and 4 treated with a water vapor concentration of 40% according to one embodiment of the present inventive concept with conventional water electrolysis electrodes.

As shown in FIGS. 22 to 24, it was confirmed that the porous nickel electrode treated with a water vapor concentration of 40% according to the present inventive concept exhibited overwhelmingly higher activity for the oxygen evolution reaction compared to electrodes manufactured by depositing various catalyst groups using the porous nickel body as a substrate without water vapor treatment.

In this way, the water vapor treatment according to the present inventive concept showed a great influence on the electrocatalytic properties of the material, especially the oxygen evolution reaction properties, in a simple manner, and this can be usefully used in the fields of energy conversion and storage.

### Experimental Example 5: Stability Measurement of Water Vapor-Treated Porous Nickel Electrode

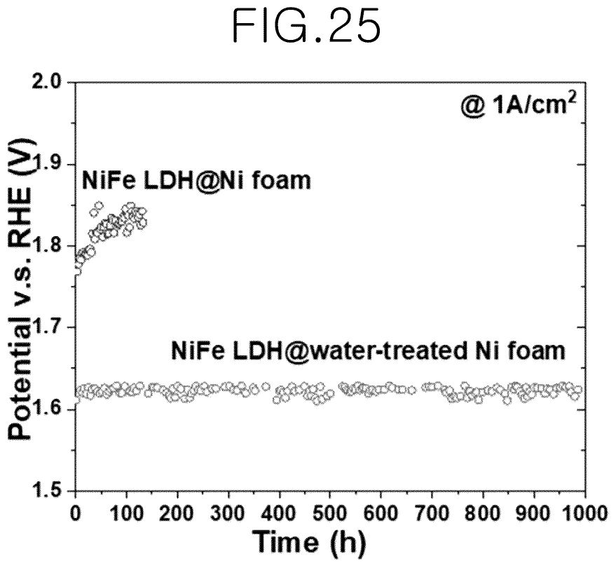

FIG. 25 is a comparative graph of long-term stability when performing an oxygen evolution reaction using an electrode in which a catalyst (NiFe LDH) is deposited on a porous nickel substrate treated with a 40% concentration of water vapor according to one embodiment of the present inventive concept and an electrode in which a catalyst (NiFe LDH) is deposited on a porous nickel substrate without water vapor treatment according to a comparative example.

As shown in FIG. 25, the nickel electrode on which the NiFe LDH catalyst was deposited without water vapor treatment stopped operating after about 150 hours of operation due to leaching of Fe, but the nickel electrode on which the NiFe LDH catalyst was deposited on the nickel substrate treated with water vapor according to the present inventive concept maintained OER activity even after 1000 hours.

Therefore, the porous nickel electrode treated with water vapor according to the present inventive concept may secure long-term stability of the catalyst.

Although preferred embodiments of the present inventive concept have been described above, it will be understood by those skilled in the art that various changes and modifications of the present inventive concept may be made by addition, alteration, deletion, or the like of the components without departing from the spirit of the present inventive concept as set forth in the claims, and that these changes are also included within the scope of the present inventive concept. For example, each component described as a single type may be implemented in a distributed form, and likewise components described as distributed may be implemented in a combined form. The scope of the present inventive concept is indicated by the following claims rather than by the above description, and all changes or modifications that come from the meaning and range of the claims and their equivalents should be construed to be included within the scope of the present inventive concept.

What is claimed is:

1. A method of manufacturing a highly active oxygen evolution electrode for water electrolysis, comprising:
exposing a surface of a nickel electrode to water vapor; and
heat-treating the electrode exposed to water vapor.

2. The method of claim 1, wherein the exposure to water vapor is exposure to a mixture of a carrier gas with the water vapor.

3. The method of claim 2, wherein the carrier gas is hydrogen gas.

4. The method of claim 1, wherein a concentration of the water vapor is 40% or more.

5. The method of claim 1, wherein the exposure to water vapor is performed at 250 to 350° C.

6. The method of claim 1, wherein the exposure to water vapor forms a hydroxide layer on the surface of the nickel electrode.

7. The method of claim 6, wherein the hydroxide layer includes NiOOH and Ni(OH)₂.

8. The method of claim 7, wherein in the hydroxide layer, a surface area of NiOOH is greater than a surface area of Ni(OH)₂.

9. The method of claim 8, wherein the NiOOH occupies 60 to 90% of a surface area of the hydroxide layer.

10. The method of claim 1, wherein the nickel electrode is a porous nickel electrode.

11. The method of claim 10, wherein a porosity of the porous nickel electrode is 90% or more.

12. The method of claim 1, further comprising removing impurities on the surface of the nickel electrode prior to the exposure to water vapor.

13. The method of claim 1, further comprising depositing a catalyst on the electrode after the heat-treating of the electrode exposed to the water vapor.

14. The method of claim 13, wherein the catalyst is a double layer hydroxide (LDH)-based catalyst.

15. A highly active oxygen evolution electrode for water electrolysis, comprising:
a nickel electrode; and
a hydroxide layer formed on a surface of the nickel electrode by exposure to water vapor.

16. The electrode of claim 15, wherein the nickel electrode is a porous nickel electrode.

17. The electrode of claim 16, wherein a porosity of the porous nickel electrode is 90% or more.

18. The electrode of claim 15, wherein the hydroxide layer includes NiOOH and Ni(OH)₂.

19. The electrode of claim 18, wherein in the hydroxide layer, a surface area of NiOOH is greater than a surface area of Ni(OH)₂.

20. The electrode of claim 19, wherein the NiOOH occupies 60 to 90% of a surface area of the hydroxide layer.
